(19) United States
(12) Patent Application Publication
(10) Pub. No.: US 2020/0281358 A1
(43) Pub. Date: Sep. 10, 2020

(54) Intensive Use Furniture

(71) Applicant: Brian Moon, Sycamore, IL (US)

(72) Inventor: Brian Moon, Sycamore, IL (US)

(21) Appl. No.: 16/436,914

(22) Filed: Jun. 10, 2019

Related U.S. Application Data
(63) Continuation-in-part of application No. 62/683,013, filed on Jun. 10, 2018.
Application No. 62/683,013 is a continuation-in-part of application No. 16/132,425, filed on Sep. 16, 2018.
Application No. 16/132,425 is a continuation of application No. 62/561,202, filed on Sep. 20, 2017.

(51) Int. Cl. A47C 5/12; B29C 41/06; B32B 3/30; B29C 41/46

(52) U.S. Cl. CPC A47C 5/12; B29C 41/06; B29L 2031/443; B29C 41/46; B32B 3/30

(57) ABSTRACT

The invention is an intensive use furniture item made by a two step molding process using heat zone control in the mold to dispense different plastic charges into the mold while controlling zones of the mold with heat being applied and thermal insulators separating mold zones for molding the bed or part of plastics differing in characteristics such as color, durability, surface finish and chemical resistance.

This application is a continuation in part of pending U.S. Provisional Patent Application No. 62/683,013, filed Jun. 10, 2018, and a continuation in part of pending U.S. patent application Ser. No. 16/132,425 filed Sep. 16, 2018 which is a continuation of pending U.S. Provisional Patent Application No. 62/561,202, filed Sep. 20, 2017.

### FIELD OF THE INVENTION

The intensive use furniture relates generally to multicolor molded furniture used in intensive use facilities and institutional settings such as health facilities, detention centers and psychiatric facilities.

### BACKGROUND OF THE INVENTION

Intensive use furniture is designed for use in demanding environments having integrally formed features and minimizing removable parts. The furniture must be designed to prevent injury to the user, either intentional or not. The Intensive use furniture may be formed by rotational or vacuum formed molding techniques known in the art. Molding furniture of plastic has meant parts typically are formed of one color base material. Additional steps to paint or color a part is used to add an aesthetic design to the part.

Rotational molding is a manufacturing method used for producing hollow, plastic articles. Typical rotational molding processes utilize high temperatures, low-pressures, and bi axial rotation, to produce hollow, one-piece parts. Significant centrifugal forces are not involved. Although rotational molding is particularly suited to producing hollow articles, the technique can provide shaped articles that compete effectively with other molding and extrusion processes, in particular, with extrusion blow molding. Rotational molding differs from all other processing methods in that the heating, melting, shaping, and cooling stages all occur after the polymer is placed in the mold. In addition, no external pressure is used to force the molten polymer into the mold. Rotational molded products are essentially stress-free, have no weld lines, and can be produced in complex shapes. In addition, mold costs are relatively low, which allows large articles to be produced economically. Typical applications of rotational molded articles are toys, various types of tanks, containers, boxes, ducts, road furniture, bumbers, display parts, light globes, etc.

The prior art teaches forming multicolor plastic molded parts by the use of removable mechanical dividers placed in a mold to segment the mold interior. A first color plastic material is placed in a first mold segment. A second mold material is placed in a second mold segment and so on to charge the segments with different plastic. Heating the mold and rotating serves to coat the interior mold segments with the respective mold plastic materials. However, the dividers may leave a blank in the skin of the part where the mechanical divider bears against the mold interior surface.

### BRIEF SUMMARY OF THE INVENTION

The present intensive use furniture may be formed by a process of heat zone control in the mold interior to isolate predefined portions of the mold interior to form a multicolor part without having to separate the mold between steps to remove dividers. The intensive use furniture comprises a multicolor skin having an integrally molded, multicolor or aesthetic design formed thereon. A two step process for rotational molding of polymers may be utilized to form the multicolor part in a single cycle by isolating the first mold portion from the second mold portion with heat control and insulating barriers. This method may include charging a first plastic material resin into a hollow mold that is heated by zones having a first step zone at molding temperature while an adjacent molding zone is cool. The cool zones are thermally isolated and heated separately to prevent the plastic from melting and coating the cool portions of the mold. The mold is rotated continuously in a uniaxial or biaxial mode at a high temperature to form hollow complex parts. In this first step only the hot portions of the mold may melt and form the plastic resin into an outer skin for the intenzivew use furniture. In a second step, an additional heat zone of the mold is heated and a second plastic material is charged into the mold. The second plastic material may differ from the first plastic resin by melting temperature, granularity or color. The mold continues to rotate along two or three axes at a low speed. The heat melts the plastic resin inside the mold and melted resin coats the heated interior surface of the mold. This process is repeated until the entire mold is coated forming the hollow part. The mold is gradually cooled and the re-solidified plastic resin, which has assumed the shape of the interior walls of the mold having colors segmented into the heat zones defined, is removed from the mold.

One embodiment of the present invention is directed to an intensive use bed for use in demanding environments, comprising a body that may be mounted on a wall or placed on a floor. The body comprises a hollow shell having a skin surrounding the hollow interior. The skin may have a multicolor aesthetic look formed in a unitary molding step to eliminate bonding colored portions by welding, adhesives or other methods. The body of an intensive use bed, for example, may comprise a sleeping surface, a pair of opposing end walls, a pair of opposing sidewalls and a bottom. The pair of opposing end walls may be integrally formed with the sleeping surface and extending downward from the sleeping surface. The pair of opposing end walls are generally parallel to each other and spaced from each other. The pair of opposing side walls may be integrally formed with the sleeping surface and extending downward from the sleeping surface. The pair of opposing side walls are generally parallel to each other and spaced from each other. Each of the opposing side walls is attached to both end walls to form a closed side surface surrounding the bottom. The bottom may be formed with the sleeping surface, end walls and side walls or may be formed separately and attached to the side surface to enclose the hollow interior of the body. Feet on the bottom may be molded into the bottom outside surface to provide a clearance for cleaning or lifting the bed.

The skin may have an exterior surface having a pattern finish for an aesthetic look. The exterior surface may by a multi color design such as a color pattern of integrally molded, connected colors or a mixed color pattern such as a pixelated design.

The vacuum formed body is formed having of sheet plastic that may be coextruded to produce an exterior pattern finish. The sheet may be extruded of a base layer polymer such as PVC having a finish layer co extruded on the top. The coextruded layer integrally forms the outside of the extruded sheet. The co extrusion may be accomplished by two or more extruders working together to form the sheet. The first extruder extruding a base sheet. The second extruder having nozzles downstream of the first extruder. The nozzles extruding the second material on the extruded sheet in a predetermined pattern. The predetermined pattern may be achieved by a plurality of nozzles disposed perpendicular to the extruded sheet flow. The plurality of nozzles intermittently dispensing extrude plastic form the second extruder onto a top surface of the extruded sheet. Each of the plurality of nozzles may be configured as a controllable dispensing nozzle as is used in inkjet printing and 3D printing. The nozzles may have motion control devices to move the nozzles laterally, across the extruded sheet to dispense the second plastic in a predetermined pattern along the extruded base sheet. The extruded sheet having the co-extruded finish on an outside surface may be vacuum molded to form a ladder for use with the wall mounted bed.

The intensive use bed may be mounted on a wall to provide a bunk bed type configuration. The furniture may have an integrally molded French cleat mounting attachment for mounting on a wall. The French cleat comprising a receiver portion integrally molded in the furniture body and a French cleat support portion attached to a wall. The French cleat receiver portion is adapted to interlock with the wall mounted French cleat support portion. The body may be molded having the French cleat receiver portion integrally molded on one or more of the opposing end walls or opposing side walls.

A ladder for use with the wall mounted bed may likewise be formed from plastic by rotationally or vacuum forming. Steps molded therein provide ligature resistant foot holds to help the user climb into the wall mounted bed. The ladder may comprise a frame and integrally molded steps for intensive use environments.

The ladder may be a corner mount ladder having ligature resistant, integrally molded steps as indentations in the front surface to allow the user to climb the ladder. A closed back on each of the steps prevent tying off a ligature. The top of the ladder may have a ligature resistant design having sloping top surfaces to prevent supporting an article from being supported thereon. The ladder is adapted to attach to the wall mounted bed, an adjacent wall or both.

The ladder may be integrally molded to a wall mounted desk. IN this embodiment, the wall mounted desk may have a work surface spaced from the floor and extending generally perpendicular to the wall. Support brackets extend from the work surface. The support brackets may attach to the wall to fix the support surface at a predetermined height. Steps may be formed in the support brackets by integrally molding ligature resistant indentations in the support brackets spaced at predetermined intervals.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is a perspective view of a first embodiment of the intensive use wall mounted bed with bed mounted first embodiment ladder.

FIG. 2 is a perspective view of a second embodiment of the intensive use wall mounted bed with wall mounted first embodiment ladder

FIG. 3 is a perspective view of the second embodiment of the intensive use wall mounted bed with bed mounted second embodiment ladder

FIG. 4 is a perspective view of a third embodiment of the intensive use wall mounted bed with bed mounted second embodiment ladder

FIG. 5 is a perspective view of the french cleat embodiment of the intensive use wall mounted bed having integrally molded french cleat receiver portion with bed mounted third embodiment ladder.

FIG. 6 is a perspective view of the second embodiment of the intensive use wall mounted bed with a wall mounted third embodiment ladder.

FIG. 7 is a perspective view of a fourth embodiment of the intensive use wall mounted bed.

FIG. 8 is a perspective view of a french cleat support portion.

FIG. 9 is an exploded view of the fourth embodiment wall mounted bed of FIG. 7.

FIG. 10 is a section view taken at approximately 10-10 of FIG. 7.

FIG. 11 is a top plan view of the fourth embodiment of FIG. 7.

FIG. 12 is a back top perspective view of a wall mounted desk.

FIG. 13 is a front plan view of the wall mounted desk of FIG. 12.

FIG. 14 is a side plan view of the wall mounted desk of FIG. 12.

FIG. 15 is a perspective view of an integral ladder in a wall mounted bed or desk.

FIG. 16 is a perspective view of a rotationally molded stackable chair.

FIG. 17 is a perspective view of a foot rest formed with the two step color process.

FIG. 18 is a front plan view of a mold having zone control heating elements.

FIG. 19 is a section view of the mold taken at approximately 19-19 of FIG. 18.

FIG. 20 is a front plan view of a chair made with the spray in mold process.

FIG. 21 is a perspective view of a two color stool.

FIG. 22 is a section view of the finish on outside surface of footstool of FIG. 21 taken at approximately 22-22.

FIG. 23 is a section view taken at approximately 23-23 of FIG. 22.

FIG. 24 is a section view of the finish on outside surface of bed of FIG. 1.

FIG. 25 is a perspective view of a mold with the top and bottom removed.

FIG. 26 is a perspective view of a mold bottom plate removed from the mold.

FIG. 27 is a perspective view of a mold top.

FIG. 28 is a perspective view of a ballast plug insert.

FIG. 29 is a perspective view of a logo insert.

FIG. 30 is a side plan view of a zone control mold.

FIG. 31 is a section view taken at approximately 31-31 on FIG. 30

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

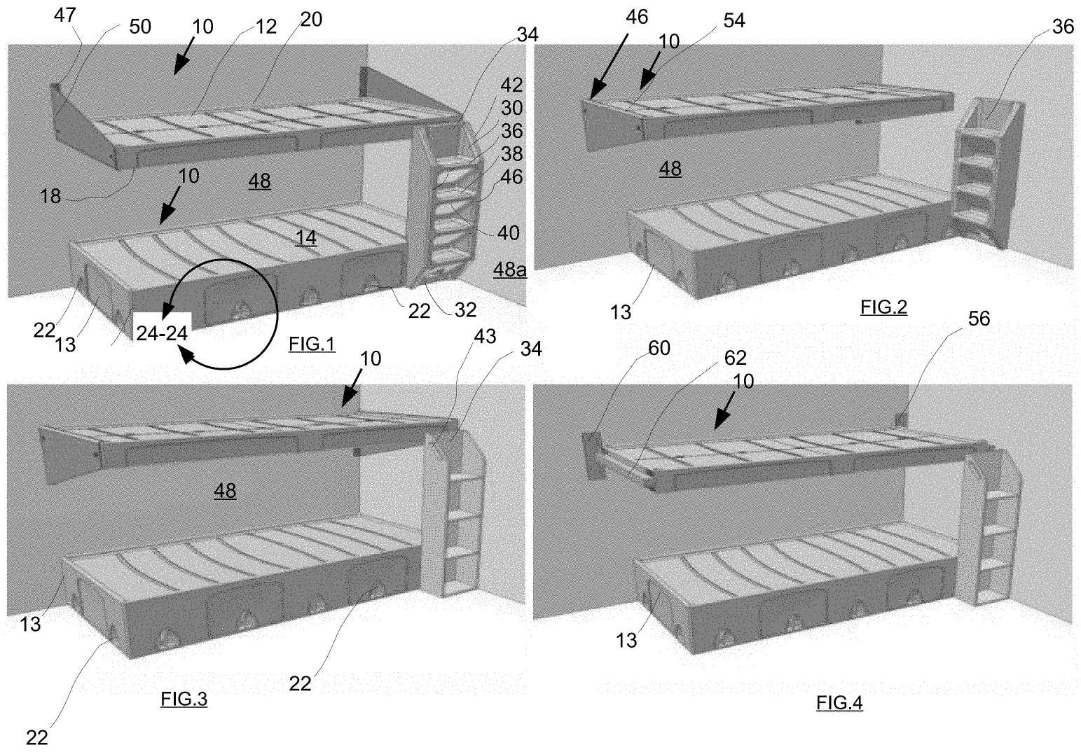

Referring to FIGS. 1-11, the intensive use furniture may be illustrated as an intensive use bed, generally indicated by reference number 10. The bed 10 comprises a generally rectangular box shape body 12 having a skin 13 disposed to form a top wall 14, a bottom 18 and a plurality of generally vertical surfaces 20. A French cleat receiver 22 may be integrally molded on one nor more of the vertical surfaces 20. Body 12 may have a generally rectangular, hollow configuration. Body 12 may be molded from plastic such as EVA by a rotational molding type process. Alternatively, the body 12 may be vacuum formed from extruded plastic sheet material.

Continuing to refer to FIGS. 1-11, a ladder 30 may be integrally molded having a floor end 32 a top end 34 and a plurality of steps 36. The steps comprise a foot landing 38 and a closed back 40 adapted to a ligature resistant design. The top end 34 has a sloped surface 42 providing a ligature resistant transition from the bed top to the ladder top 34. The ladder 30 may have a wall mount surface 46 and may be attached to the bed 10. Ladder 30 may also have a handle 43. Wall bracket 46 may be generally trapezoidal having a wall flange 47 on the wall 48 and a support 50 extending generally perpendicular to the wall 48. The support 50 attached to one end 52 of the bed 10.

Continuing to refer to FIGS. 1-11, Wall bracket 46 may be reversible having the generally ligature resistant side 54 on the top surface of the bed 10. T-bar bracket 56 may have a wall plate 60 with bed support 62 extending generally horizontal from plate 60.

Referring to FIG. 8, french cleat support 70 may comprise a wall surface 72, a plurality of screw holes 74, a protrusion portion 76 and an engagement surface 78. engagement surface 78 is adapted to engage french cleat receiver 22 (FIG. 1).

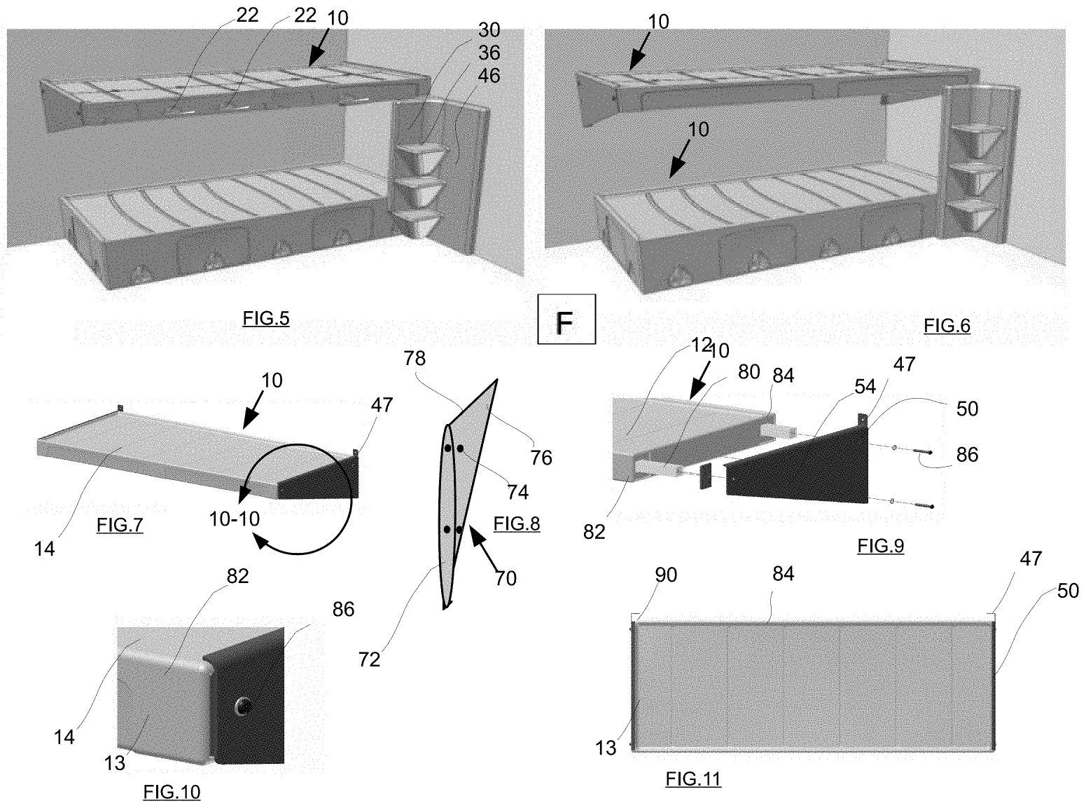

Referring to FIGS. 9-11, rods 80 may be extended through bed 10 between support brackets to support bed 10 along front side wall 82 and back side wall 86. bolts 86 extend through bracket into rods 80 to secure bed 10 between opposing support brackets. Flange 47 may be offset form backside wall 84 to create anti contraband space 90.

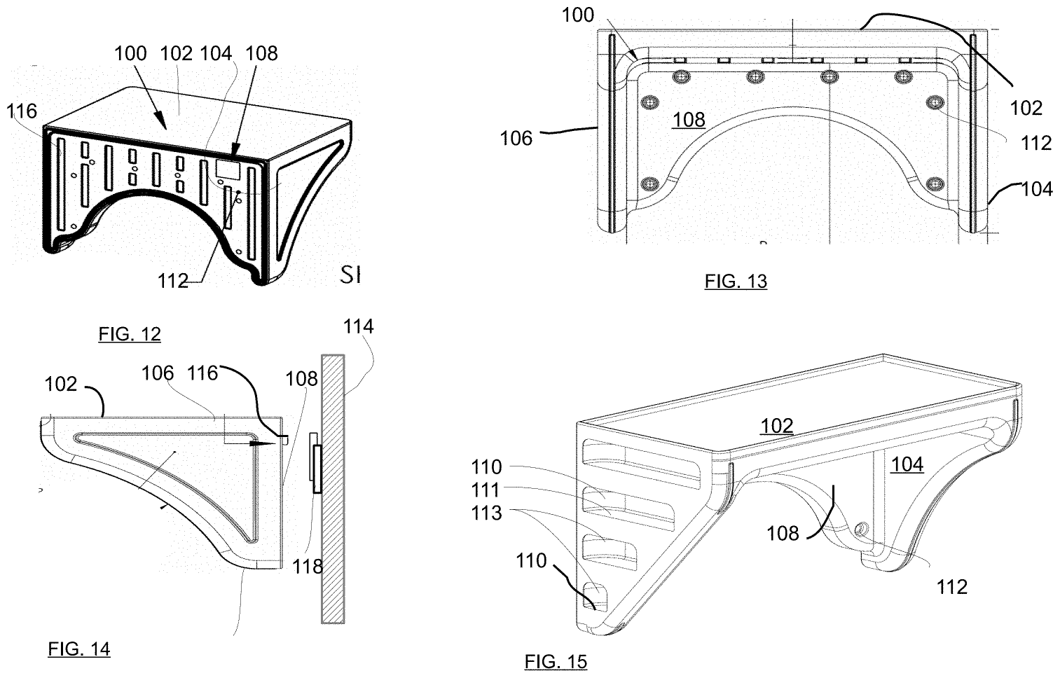

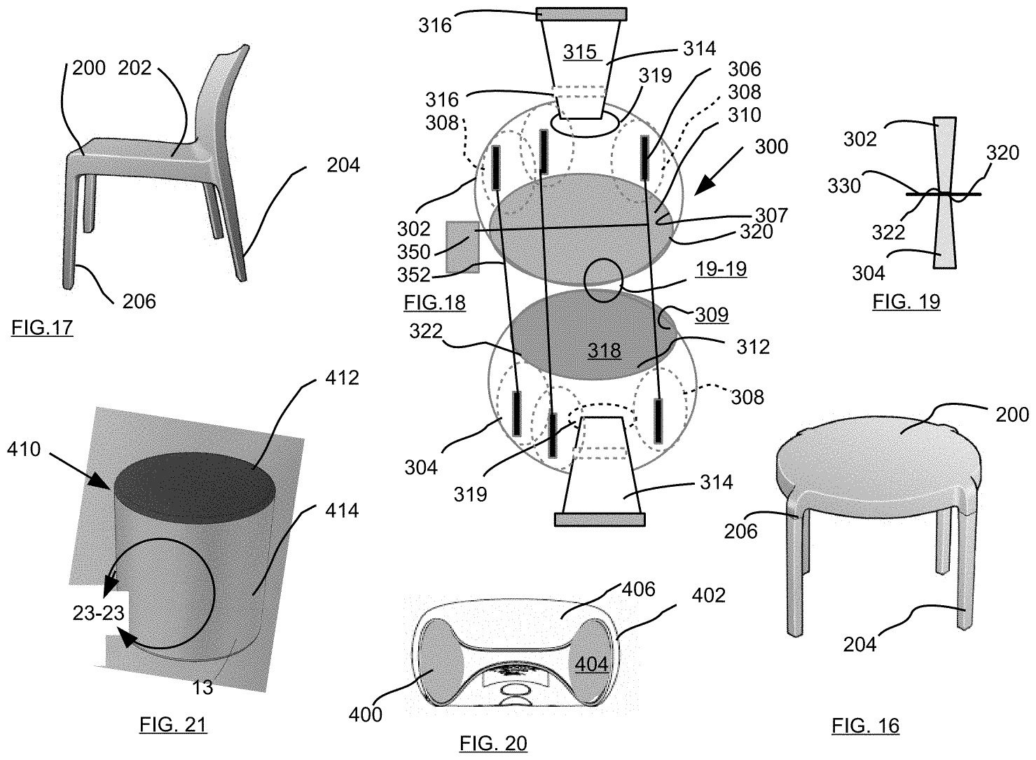

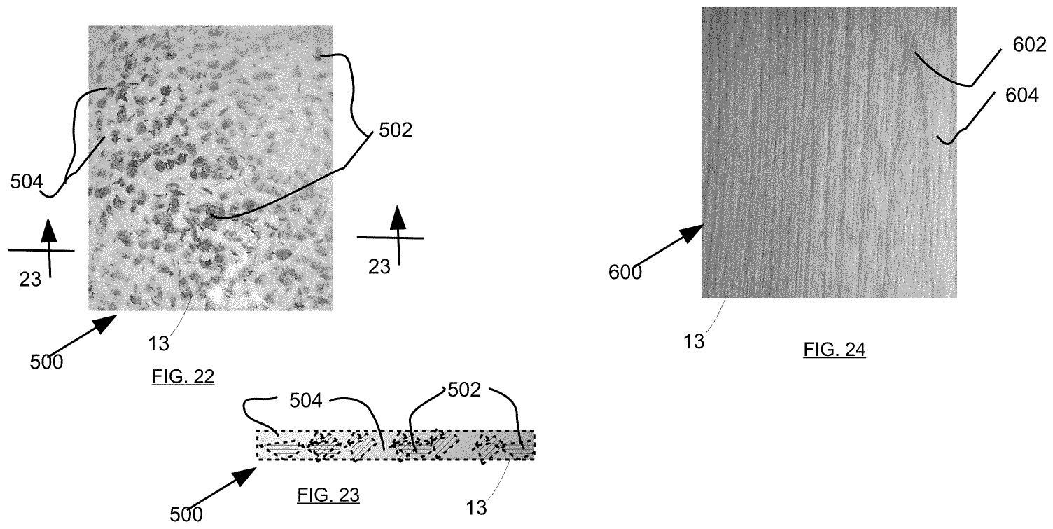

Referring to FIGS. 12-15, wall mounted desk 100 may comprise a French cleat receiver 116, writing surface 102, a first side support 104, second side support 106, back plate 108 and steps 110. Bolt holes 112 are adapted to fasten wall mounted desk 100 to a wall 114. French cleat receiver 116 may be integrally formed in back plate 108. French cleat receiver 116 adapted to engage french cleat support 118 attached to wall 114. Steps 110 may comprise a plurality of ligature resistant steps 111 having closed backs 113 to prevent ligature tie off.

Referring to FIGS. 16-17, a multicolor molded stackable chair 200 may have a seat 202 and different colored, integrally molded, legs 204. Chair 200 may have a two color exterior 206. Likewise, stool 410 may have a multicolor design with an integrally molded top 412 having a first color and a body 414 with a second color.

Referring to FIG. 18, mold 300 may have a first portion 302 and a second portion 304, a plurality of heating elements 306 and a drop box 314. First mold portion 302 is adapted to bear against second mold portion 304 to isolate mold cavity 318. Each of the plurality of heating elements 306 may be adapted to heat or cool an adjacent temperature zone 308 on mold 300. Each of the plurality of heating elements 306 may be an electrical element or a fluid dispenser to apply hot or cool liquid to its respective zone 308. Each of the plurality of heating elements 306 is disposed in a predetermined pattern with respect to each other and the mold 300. The predetermined pattern is adapted to create separate heat/cooling zones 308. The zones 308 will be discussed herein as heat zones for purpose of this discussion. It should be understood, the heating elements 306 may also be adapted to cool its respective zone. The first mold portion 302 may comprise a hollow interior forming first mold cavity 310 surrounded by the first mold portion 302. First mold cavity comprises mold wall 307 and mold lip 320. Mold lip 320 may have insulator 322 thereon. Second mold portion 304 may comprise a hollow interior forming second mold cavity 312. Second mold portion 304 further comprises mold wall 309 and second mold lip 322. Second mold lip 322 surrounds second mold cavity 312. Second mold lip 322 and first mold lip 320 are adapted to sealingly bear against insulator 330 to enclose and hold first mold cavity and second mold cavity in fluid communication.

Continuing to refer to FIG. 18, mold 300 may further comprise drop box 314 mounted on mold opening 319, Drop box 314 may comprise plastic holding chamber 315, dispenser valve 316 and lid 317. Drop box 314 may be attached to mold 300 at mold opening 319 whereby chamber 315 is in fluid communication with first mold cavity 318 when dispenser valve is in an open position. Dispenser valve 316 is adapted to move from an open position to a closed position whereby chamber 315 is isolated from first mold cavity 318. Lid 317 closes drop box 314 to prevent plastic material from exiting drop box 314. Plastic material processed to a predefined shape and size is placed in the hollow chamber 315. The lid 317 is closed to seal the hollow chamber 315. Dispenser valve may be opened tlet. In the open position, open box is in communication with mold interior. Drop box 314 may be mounted in mold opening 319.

Continuing to refer to FIG. 18, control 350 may be connected to heating elements 314 and dispenser valve by connector 352. Each heating element 306 may be adapted to heat or cool its particular zone 308. Side by side color design 410 may be formed using heat zone control with the mold of FIG. 18. First color 412 may be in first mold cavity 310 and second color 414 may be in second mold cavity 312.

Referring to FIG. 19, first mating surface 320 bears against second mating surface 322. Insulator 330 may be disposed between first mating surface 320 and second mating surface 322. Insulator 330 may be a tape or sheet made of a polymer material such as Teflon® having heat insulating characteristics. The insulator 330 thermally isolates the first mold portion 302 from the second mold portion 304.

Referring to FIGS. 18 and 20, a two color intensive use furniture piece 400 may be formed by molding a color panel 404 onto body 402. Color panel 404 may be formed by providing a first colored spray on polymer type liquid, applying the first colored polymer to first mold cavity 307 (FIG. 18) after preheating. Mold 300 may be closed and stepped through the molding cycle with a second color plastic material 402 inserted in second mold cavity 319.

Using heat zone control to create a heat profile in the mold 300, first mold cavity 310 is heated to temperature isolating second mold cavity 312 by insulator 330 to prevent heat transfer from first mating surface 320 to second mating surface 322. First color 412 is dispensed into the mold interior and the mold rotated in two axis as standard roto-molding process. After a predetermined time, based on the particular polymer used and respective temperatures, control 350 energizes one or more of the plurality of heater elements 306 in second mold cavity 312. The second color 414 is dispensed into mold interior 318 for melting and adhering to mold interior 318.

The two step drop box process comprises the steps of:

1. Assemble the mold 300 having the first mold portion 302 attached to the second portion 304 with insulator 330 there-between.

2. Mount drop box 314 on first drop box opening 319.

3. Place first color plastic material 412 in mold interior 318.

4. Seal second drop box opening on second mold portion if needed.

5. Place second color plastic material 414 in drop box 314, close lid.

6. Determine first and second rotation times.

7. Energize a predetermined ones of the plurality of heating elements 306 on first mold portion 310 to first mold cavity 307 to a predetermined temperature.

8. Rotate mold 300 in x and y planes urging plastic material to melt and coat first mold cavity 307.

9. Pause a predetermined time having the first mold portion 302 oriented below second mold portion 304 above.

10. Dispense second plastic 414 into mold interior by opening drop box gate 316.

11. Close gate 316.

12. Energize a predetermined set of the plurality of heating elements 306 in second mold cavity 309 to a predetermined temperature.

13. Rotate mold 300 in x and y planes for second rotation time.

14. Cool mold 300 by de-energising heating elements 306 or energizing cooling elements 306

15. Disconnect first mold portion 302 from second mold portion 304.

16. Remove part.

It should be understood, a mold 300, having a plurality of cavities 307, 309 may be used to create a device having several different colors or alternating colors formed by the single, multi step process of heating individual sections of the mold, exposing the heated sections to a plastic material and repeating until the device is fully formed. The intensive use furniture part comprising a hollow body, the hollow body having a skin formed to surround a hollow inside. The skin further comprising an outer layer, the outer layer comprising a first portion having a first color, a second portion having a second color, the second color on the skin between the first color and the hollow inside. The intensive use chair comprising a multi layer skin comprising the first color on the outside and the second color on the inside, the inside surrounding the hollow inside. The intensive use chair further comprising a ballast hole in the skin, a ballast plug in the ballast hole, the wherein the hollow inside further comprises a ballast chamber.

Referring to FIGS. 23-24, a pixilated finish 500 may be formed by a pixelating process 184 by creating a mixture of a first granulated plastic material 502 having a first color and a second powered plastic material 504 having a second color. The pixilated finish 500 comprises granules 502 partially melted on the mold cavity 307, 309 and finely ground or powdered plastic material 504 added to the mold cavity 307, 309 before the granulated material 502 melts fully. The pixilated finish 500 comprises granules 502 surrounded by finely ground plastic material 504 wherein both are melted and formed together to give the look of stone or concrete. The pixilated finish 500 may be achieved by the process of the following steps:

1. Assemble the mold 300 having the first mold portion 302 attached to the second mold portion 304 with insulator 330 there-between.

2. Mount drop box 314 on first drop box opening 319.

3. Mount second drop box 314 on second drop box opening 319.

4. Energize first heating element 306 to heat first mold cavity 307 to a predetermined temperature.

5. Energize second heating element 306 to heat mold portion 304 to a predetermined temperature.

6. Determine and set rotation time.

7. Place first color plastic 502 having a first granulated size in the mold 300.

8. Place second color plastic 504 having a powered granulation size in the mold 300.

9. Rotate mold 300 in x and y planes.

10. Rotate mold 300 in x and y planes for a predetermined time.

11. Cool mold 300 by de-energizing first and second heating elements 306.

12. Disconnect first mold portion 302 from second mold portion 304.

13. Remove part.

It should be understood, a one step pixelating process 500 may be achieved without the use of the drop box. The large blobs of the first color plastic 504 are formed by the granulated plastic pieces 504 melting onto the mold cavity 307, 309. The gaps between granulated pieces is filled with the powered second plastic having a different color form the granulated plastic.

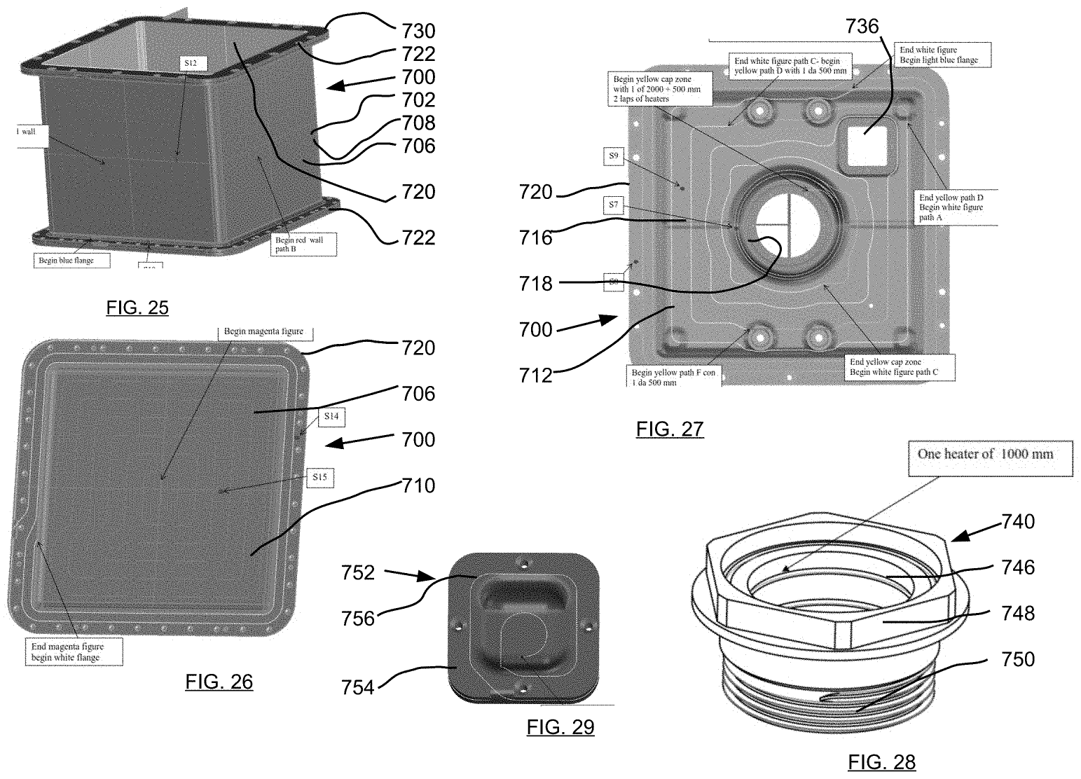

Referring to FIGS. 25-27, mold 700 comprises body 708, bottom 710 and to 712, mold body 708 may comprise flange 722 to support top 712 and bottom 710. Mold 700 may further comprise insulator 730 on flange and heater elements 706 disposed on the outside of mold 700. Mold cavity 720 is surrounded by mold 700 when assembled having mold top and mold bottom attached thereto. Mold bottom may comprise mating flange 720 adapted to bear on insulator 730 to close mold cavity 720. Mold top 712 may further comprise mold flange 720 heater elements 716 and drop box opening 718. Drop box 718 may be occupied by Ballast plug adapter 740. Mold top 713 may further comprise logo port 736. Logo port 736 may be adapted to receive logo insert 752 therein. Logo insert 752 may further comprise insert heater element 756 disposed adjacent insert flange 754. Ballast plug insert 740 may comprise threaded portion 750 for attaching to mold 700, plug heater element 746 and grip 748.

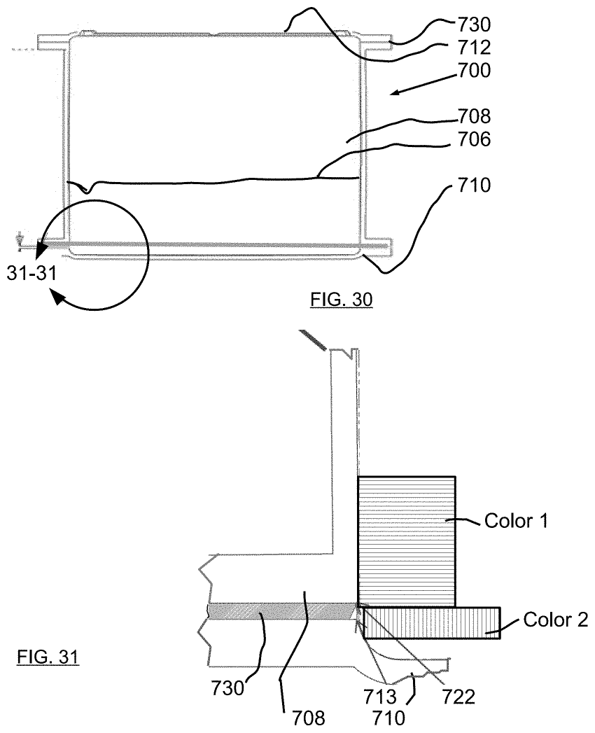

Referring to FIG. 30-31, Mold insulator 730 may be a peek 730 placed between the mold portions 708, 710, and 712. The peek 730 having a thickness that tapers to a point 713 to allow contact at the mold flange surfaces 720 while minimizing heat transfer between mold portions 708, 710, 712.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made without departing from the spirit and scope of the invention which is defined in the following claims.

I claim:

1. An intensive use chair comprising:
a hollow body, the hollow body having a skin formed to surround a hollow inside. The skin further comprising an outer layer, the outer layer comprising a first portion having a first color, a second portion having a second color, the second color on the skin between the first color and the hollow inside.

2. The intensive use chair of claim 1 further comprising a multi layer skin comprising the first color on the outside and the second color on the inside, the inside surrounding the hollow inside.

3. The intensive use chair of claim 1 further comprising a ballast hole in the skin, a ballast plug in the ballast hole, the wherein the hollow inside further comprises a ballast chamber.
